(19) United States
(12) Patent Application Publication
(10) Pub. No.: US 2009/0313304 A1
(43) Pub. Date: Dec. 17, 2009

(54) Systems and Methods for Capturing, Organizing, and Sharing Data

(76) Inventors: Rodney Goodger, San Jose, CA (US); Mario Cavagnari, Scotts Valley, CA (US); Michael Galloway, San Jose, CA (US)

Correspondence Address: CARR & FERRELL LLP, 2200 GENG ROAD, PALO ALTO, CA, 94303, US

(21) Appl. No.: 12/324,697

(22) Filed: Nov. 26, 2008

Related U.S. Application Data
(60) Provisional application No. 61/061,520, filed on Jun. 13, 2008.
(60) Provisional application No. 61/076,586, filed on Jun. 27, 2008.
(60) Provisional application No. 61/095,925, filed on Sep. 10, 2008.
(60) Provisional application No. 61/102,858, filed on Oct. 5, 2008.

(51) Int. Cl. G06F 17/30; G06F 15/16; G06F 17/00

(52) U.S. Cl. 707/104.1; 709/206; 715/234; 707/E17.019; 707/E17.014; 707/E17.032; 707/E17.044

(57) ABSTRACT

A method for saving visual data that was captured from a data source is disclosed. Visual data is received via a network from a computing device coupled to the network. The visual data includes image data and non-image data. An item of content is generated based on the selected visual data from the data source for storage in a database coupled to the network.

### CROSS-REFERENCE TO RELATED APPLICATIONS

This application claims the benefit of U.S. Patent Application Ser. No. 61/061,520 filed on Jun. 13, 2008, entitled “System and Method for Capturing and Visually Organizing Screen Shot Segments,” U.S. Patent Application Ser. No. 61/076,586 filed on Jun. 27, 2008, entitled “Capturing and Sharing Screen Segments,” U.S. Patent Application Ser. No. 61/095,925 filed on Sep. 10, 2008, entitled “Methods and Media for Embedded Content,” and U.S. Patent Application Ser. No. 61/102,858 filed on Oct. 5, 2008, entitled “Systems and Methods for Capturing, Organizing and Sharing Data.” The disclosures of all the above U.S. patent applications are incorporated by reference herein.

### FIELD OF INVENTION

The present invention relates generally to data manipulation, and more particularly to capturing, organizing and sharing data.

### BRIEF SUMMARY OF THE INVENTION

Embodiments of the present invention provide systems and/or methods for capturing, organizing and sharing data. In a non-exhaustive list, data can include a webpage, a portion or a screen shot of a webpage, a frame of an online video, an image, a binary image, a photo, a picture, an electronic signature, a document, a scanned document, an electronic mail message, a hyperlink, text, a web book, an online article, webpage formatting, and any portions and/or combinations thereof. In some embodiments, data may include visual data accessible via a data source. A data source may be any source that supplies, provides, generates, furnishes, stores and/or displays any of the aforementioned types of data or any combinations thereof. A data source may include or be coupled to a database. In some embodiments, a data source may include a computing device such as a mobile device. In some embodiments, a data source may be a repository of data. In some embodiments, the data is accessible online via the Web or another network from one or more data sources. In other embodiments, the data is accessible from a user's desktop or mobile device.

In a first aspect, a computer-readable storage medium having embodied thereon a program, the program being executable by a computer to perform a method for capturing data from a webpage is disclosed. The method for capturing data from a webpage includes receiving a request to capture data of a webpage. Selected data from the webpage is received. An item of content is generated based on the selected data from the webpage.

In a second aspect, a computer-readable storage medium having embodied thereon a program, the program being executable by a computer to perform a method for capturing and sending a segment of a content page, such as a webpage, is disclosed. The method includes receiving a send request from a user device. A capture region within a webpage displayed on a user device display is identified. The capture region is indicated on the display. Data based on the capture region is received. Data associated with a recipient address is received. A link associated with the webpage is sent to the recipient address. The received data is sent to the address.

In a third aspect, a computer-readable storage medium having embodied thereon a program, the program being executable by a computer to perform a method for saving a region of a webpage displayed on a display of a computing device by a browser is disclosed. The method includes receiving a request from a user of the browser to save a region of the webpage. Browser activity is suppressed on the computing device. A definition of a region of the webpage is received. One or more boundaries of the defined region are provided on the browser. An extraction of image data from the defined region is initiated. An extraction of non-image data from the defined region is initiated. A set of categories is provided. A selection of a category is received. An item of content is generated based on the extracted image data and the extracted non-image data. Preferably, the item of association is generated based on an association of the extracted image data and the extracted non-image data from the defined region of the webpage. Suppression of browser activity is released.

In a fourth aspect, a method for saving visual data captured from a data source is disclosed. Visual data captured from a data source is received via a network from a computing device coupled to the network. The visual data includes image data and non-image data. An item of content based on the selected visual data from the data source is generated for storage in a database coupled to the network.

In a fifth aspect, a method for sharing visual data from a data source is disclosed. Visual data is received from a computing device coupled to the network. The computing device has a display. An item of content is generated based on the visual data received from the computing device. Data associated with a recipient address from a second user input to the computing device is received. A link associated with the data source is sent to the recipient via one or more web servers coupled to the network. The generated item of content is sent to the recipient address via the one or more web servers.

In a sixth aspect, a method for saving a region of a data source displayed on a display of a computing device by a browser is disclosed. Image data and non-image data from the data source is received via a network. The computing device is coupled to the network. A set of categories is received from a server coupled to the network and provided to the computing device. An item of content is generated based on the image data and non-image data from the data source for storage in a database coupled to the network.

The methods described herein may be performed via a set of instructions stored on storage media (e.g., computer readable media). The instructions may be retrieved and executed by a processor. Some examples of instructions include software, program code, and firmware. Some examples of storage media comprise memory devices and integrated circuits. The instructions are operational when executed by the processor to direct the processor to operate in accordance with embodiments of the present invention. Those skilled in the art are familiar with instructions, processor(s), and storage media.

### BRIEF DESCRIPTION OF THE DRAWINGS

FIG. 1 is an exemplary networking environment in accordance with embodiments of the invention.

FIG. 2 is a flowchart of an exemplary method for capturing data in accordance with embodiments of the invention.

FIG. 3 is a flowchart of an exemplary method for executing a “Box and Save” command in accordance with embodiments of the invention.

FIG. 4 is a flowchart of an exemplary method for executing a “Box and Send” command in accordance with embodiments of the invention.

FIG. 5 illustrates a webpage and toolbar in accordance with the embodiments of the invention.

FIG. 6 illustrates a grayed webpage and toolbar of FIG. 5 in accordance with the methods described in FIGS. 3 and 4.

FIG. 7 illustrates the webpage and toolbar of FIG. 6 in accordance with the methods described in FIGS. 3 and 4.

FIG. 8 illustrates the webpage and toolbar of FIG. 7 in accordance with the methods described in FIG. 3.

FIG. 9 illustrates the webpage and toolbar of FIG. 7 in accordance with the methods described in FIG. 4.

FIG. 10 illustrates a third party e-mail in accordance with the methods described in FIG. 4.

FIG. 11 illustrates details of an alert provided in the toolbar of FIG. 5.

FIG. 12 illustrates a host application providing a grid layout for accessing boxes and items of content in accordance with embodiments of the invention.

FIG. 13 illustrates a host application webpage including a grayed out box and a dialog box for activating sharing in accordance with embodiments of the invention.

FIG. 14 is a flowchart illustrating a method for capturing data from a webpage.

FIG. 15 is a flowchart illustrating a method for capturing and sending data.

FIG. 16 is a flowchart illustrating a method for saving a region of a webpage displayed by a browser.

FIG. 17 illustrates an exemplary “free-form” layout of items of content.

FIG. 18 illustrates an exemplary “list view” layout of items of content.

FIG. 19 is a flowchart illustrating a method for saving visual data captured from a data source.

FIG. 20 is a flowchart illustrating a method for sharing visual data from a data source.

FIG. 21 is a flowchart illustrating a method for saving image data and non-image data from a data source.

### DETAILED DESCRIPTION

The world wide web is a source of a vast array of information. A user can access content on the web by running a browser, such as Mozilla or Internet Explorer, on a computing device. The computing device may be a desktop computer, laptop or any device that computes. Vast arrays of information may be accessible via data sources coupled to networks other than the world wide web. For example, data can be supplied by one or more data sources within a local area network, a wide area network, and/or a mobile network. Embodiments of the present invention allow for capturing, organizing, and/or sharing data from a webpage or other data source without having to navigate away from the webpage. Such data may also be accessed locally from a computing device without navigating away from the data source. This in turn allows for more convenient data capture, organization, and/or sharing while navigating or “surfing,” seamlessly throughout the Internet or other data source with minimal interruption. Selected data is captured such that it may be stored and/or shared. In some embodiments, the sharing and storing of captured data may be facilitated by an application and/or network service which may manage one or more user accounts.

Embodiments of the present invention provide systems and methods for capturing, organizing and sharing data. In a non-exhaustive list, data can be a webpage, a portion or a screen shot of a webpage, a frame of an online video, an electronic signature, an image, a binary image, a photo, a picture, a document, a scanned document, an electronic mail message, a hyperlink, text, a web book, an online article, webpage formatting, and any portions and/or combinations thereof. In some embodiments, data may include visual data accessible via a data source. A data source may be any source that supplies, provides, generates, furnishes, stores and/or displays any of the aforementioned types of data or any combinations thereof. In some embodiments, a data source may include or be coupled to a database. In some embodiments, a data source may be a repository of data. In some embodiments, the data is accessible online via the Web or another network from one or more data sources. In other embodiments, the data is accessible from a user's desktop or mobile device. Preferably, the data captured is that of an image. Metadata associated with an image can specify a URL, file pointer, tags, or other information which provides an identity of the source such that the user can return to the original source that the image was taken. Additionally, metadata that may be associated with an image may include text, links, scripts, applets, properties of the image and/or the like. In some embodiments, metadata may include text enclosed in the selection region of the image, user added comments, and any other non-image data. Image data and metadata may be associated with an item of content. Although the following discussion pertains to webpages in detail as an exemplary data source, one of ordinary skill in the art will understand that the discussion pertains to any data source that can be accessible to a computing device and/or network. Furthermore, the technology allows for visual data to be captured, organized, and/or shared via an application and/or network service.

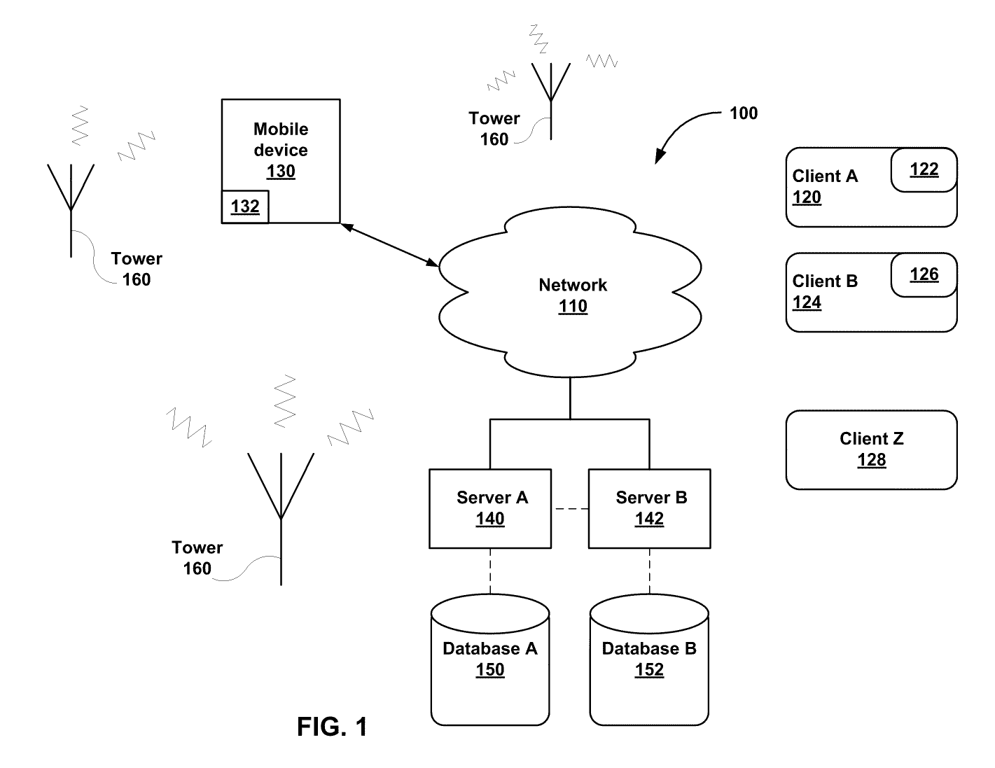

FIG. 1 is an exemplary networking environment 100 in accordance with embodiments of the present invention. For all figures mentioned herein, like numbered elements refer to like elements throughout. The networking environment 100 includes network 110, a mobile device 130, servers A 140 and B 142, databases A 150 and B 152, clients A 120, B 124 and Z 128, and towers 160. The network 110 can be any type of network, including but not limited to the Internet, LAN, WAN, and any other communication network that allows access to data, as well as any combination of these. The network 110 is coupled to servers A 140 and B 142, clients 120, 124 and 128, and mobile device 130.

The servers A 140 and B 142 are coupled to databases A 150 and B 152, respectively. It will be apparent to one skilled in the art that the invention is not limited to any particular type of network, server and/or database. In some embodiments, the servers A 140 and B 142 are configured to control and route information via the network 110, as well as access, retrieve, store and otherwise process data stored on databases A 150 and B 152. In some embodiments, the servers A 140 and B 142 include web servers. The databases A 150 and B 152 are configured to store and manage data. In some embodiments, the databases A 150 and B 152 are configured to store captured data or data otherwise accessed or retrieved from webpages, local client devices, and/or other data sources. Databases A 150 and B 152 may also store and manage user account data for the network service (not shown). For example, the databases A 150 and B 152 may store and manage data comprising a current snapshot of one or more user accounts. In another example, the databases A 150 and B 152 store and manage data comprising an image of a selected region of a webpage and/or metadata associated with the selected region. In some embodiments, a snapshot preserves current contents of a box and/or the state of a box.

The databases A 150 and B 152 may also include a historical action log. For example, the databases A 150 and B 152 may store information about e-mails associated with a user account and generated by a user (in conjunction with one or more servers). The information may be stored by the network service or by a service not affiliated with the network service. The information may provide direct links to items of content in the user's box. Further, the databases A 150 and B 152 can store information about whether such e-mails were sent, time stamp information (such as when they were sent), and the contents of the e-mails.

The networking environment 100 is configured to service one or more computing devices, such as clients A 120, B 124 and Z 128 and mobile device 130. One skilled in the art can appreciate that the networking environment 100 is exemplary only and that it is not limited to what is shown in FIG. 1. For instance, although FIG. 1 shows that the networking environment 100 includes three clients (namely, client A 120, client B 124 and client Z 128), any number of clients can be serviced by the network 110. Clients A 120, B 124, and/or Z 128 may be implemented as web servers, or be in communication with one or more web servers. Further, clients A 120, B 124, and/or Z 128 can be coupled or in communication with one another. In other words clients A 120 and B 124 can communicate with each other through network 110 or through any other manner. Similarly, any number of servers, databases, networks and mobile devices can be included in the networking environment.

This technology may be performed via an application that includes a set of instructions stored on storage media (e.g., computer readable storage media). Such an application may include a desktop application. The set of instructions may be retrieved and executed by a processor. Some examples of instructions include software, program code, and firmware. Some examples of storage media include memory devices and integrated circuits. The instructions are operational when executed by the processor to direct the processor to operate in accordance with embodiments of the present invention. Those skilled in the art are familiar with instructions, processor(s), and storage media. Such storage media may be available, for example, in clients A 120, B 124 and Z 128 as well as in databases 150 and 152. Such processors may be available, for example, in servers A 140 and B 142, as well as in clients A 120, B 124, and Z 128.

One or more clients of networking environment 100 may include an application (e.g., a desktop application). Further, one or more clients may include displays that may display web browsers (not shown). In some embodiments, a desktop application is an application that is stored on the local memory of a server, client, mobile device, or some other device, and is run on the device's operating system. For example, a desktop application may be implemented as a client application. As shown in exemplary FIG. 1, client A 120 has application 122, which may be a client application, a desktop application, or a stand-alone application that may be stored in a memory and executed by a processor. Similarly, client B 124 has an application 126. It will be appreciated by one skilled in the art that the application 122 does not have to be resident on the client A 120's desktop. The application 122 can be coupled in any manner to client A 120, as described herein. The application may be a web-based application.

FIG. 1 further shows that client Z 128 does not have an application. More details shall be given later herein as to how the present technology works for clients who have the application (such as clients A 120 and B 124) and those clients who do not have the application (such as client Z 128). In the context of particular embodiments later described herein, clients A 120 and B 124 may be considered network service users as they both have associated applications. Client Z 128, a client without a client or desktop application, is considered a non-user of the network service since client Z 128 does not have an associated application. Such applications 122 and 126 may render graphics, such as icons and other graphic images, on a graphic interface provided through a display (not shown) of clients A 120 and B 124, respectively.

Still referring to FIG. 1, a mobile device 130 may serve as a computing device in accordance with the present technology. Mobile device 130 may be implemented as a desktop application, a client application, and/or a stand-alone application like applications 122 and 126. Similarly, mobile device 130 may include a display (not shown) that may display a web browser. Mobile device 130 may be serviced by network 110 and operably coupled to one or more towers 160 and the network 110. In some embodiments, the mobile device 130 is a client that is serviced by one or more servers, such as servers A 140 and B 142, via the network 110. In some embodiments, the mobile device 130 includes and is operable to execute an application 132. The mobile device application 132 may capture data. Exemplary data may include data local to the mobile device. Mobile device 130 may transmit the captured data to be stored on one or more databases, such as databases A 150 and B 152 via application 132. In other embodiments, the mobile device 130 does not include an application. One skilled in the art will recognize that although FIG. 1 shows only one mobile device 130, network 110 may be configured to service any number and/or type of mobile device.

In one embodiment, a user of a client device may log into a user account via a server over the network 110 to establish a connection with the server. Once the connection is established, a user may initiate communications with the server (e.g., through an application of the present technology) to receive and transmit captured content and share that content with others via the network 110. Additionally, a user account may be used to access content associated with other user accounts. For example, a user account may be used to access content that is captured and shared by other users with the particular user.

The application (such as application 122 in FIG. 1) can be accessed in a variety of ways. In some embodiments, a user installs the application. Application may be installed, for example, as code implementing an add-on to the web browser (not shown). In some embodiments, the application incorporates one or more scripts that when executed perform one or more methods according to the embodiments described herein. In other embodiments, a user installs an application, such as a client application, to execute on their computer. In some embodiments, the client application can be configured to perform one or more methods according to the embodiments described herein. As discussed above, the application can be implemented as a desktop application, client application, or stand-alone application. In some embodiments, the application can be implemented as part of an operating system. In any case, the application can be viewed on a graphic interface provided by the operating system. For example, the application may be viewed on a “desktop” image which displays program icons and other graphics. An application icon may be provided such that the application icon may be selected or clicked on by a user to launch the application. In another example, the application can be started through a context menu item. For example, the user may right-click on the context menu item and select a resulting item of a menu associated with starting the application, such as “Start Application.” In some embodiments, the application may execute in the background. A message may be passed from a context menu, a toolbar, or any other means to begin the application.

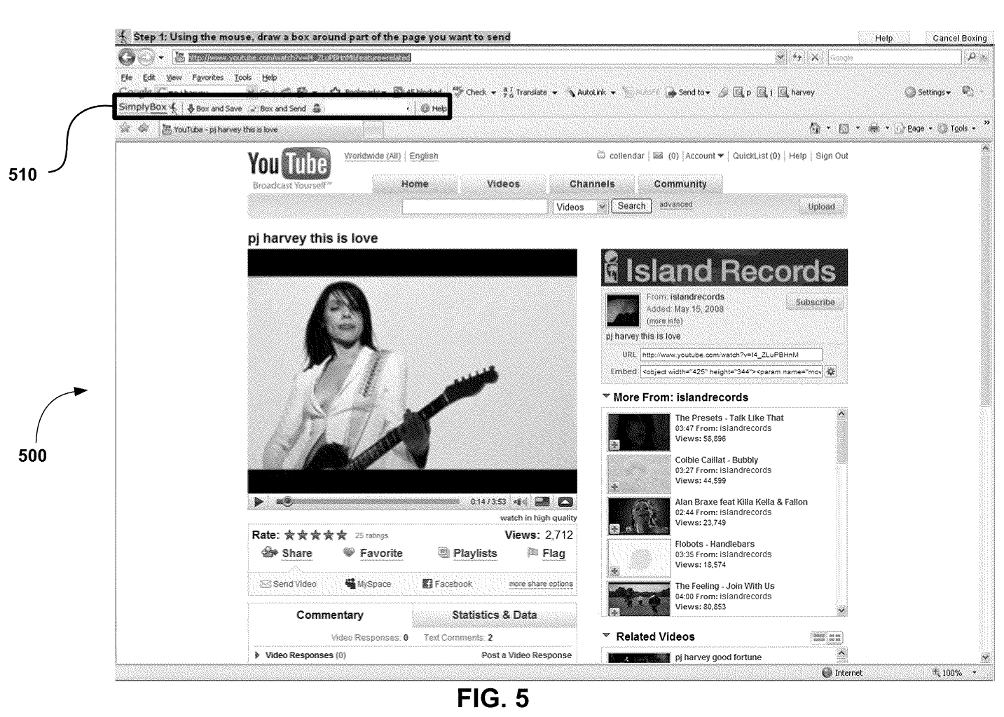

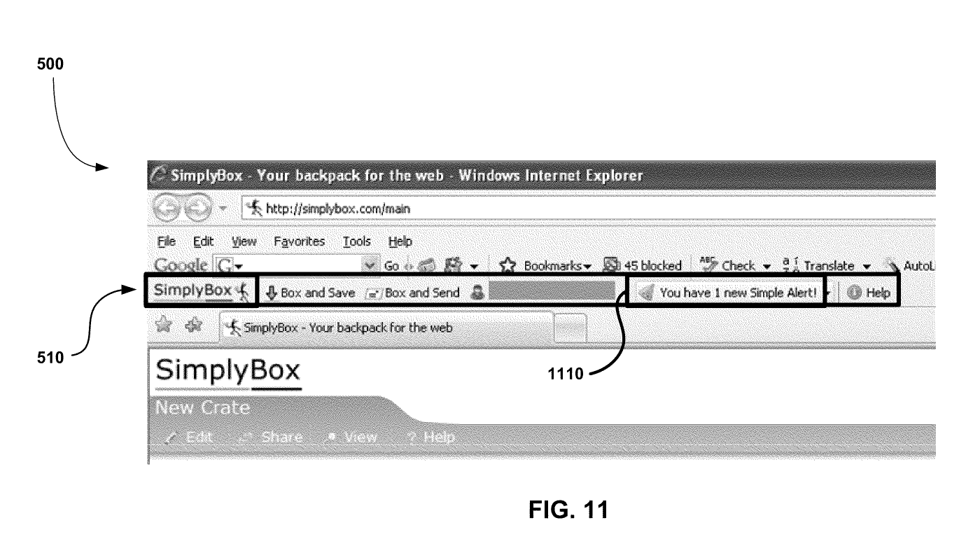

The application (whether implemented as a client application, browser application add-on, or in some other embodiment) may install several buttons on a toolbar of the browser window. An exemplary toolbar 510 is illustrated in FIGS. 5, 10, and 11. When a user clicks on one of these buttons, the application starts a process to capture items of content from the current webpage without the user having to navigate away from that webpage on the browser. Such a process is illustrated in FIGS. 5-10. Captured content may include text, image, metadata, video, links, tags, data base, and/or the like. Other features may also be available on the toolbar. For example, a button that allows for the capture of content from a local computer display or a button to access the network service may be provided (not shown). In some embodiments, an alert window may also be located on the toolbar, which serves to notify the user of a new item of content. An example of an alert window 1110 is illustrated in FIG. 11. In some embodiments, a toolbar is installed onto the browser window, the application may run in the background and the user may not have to be logged into the application.

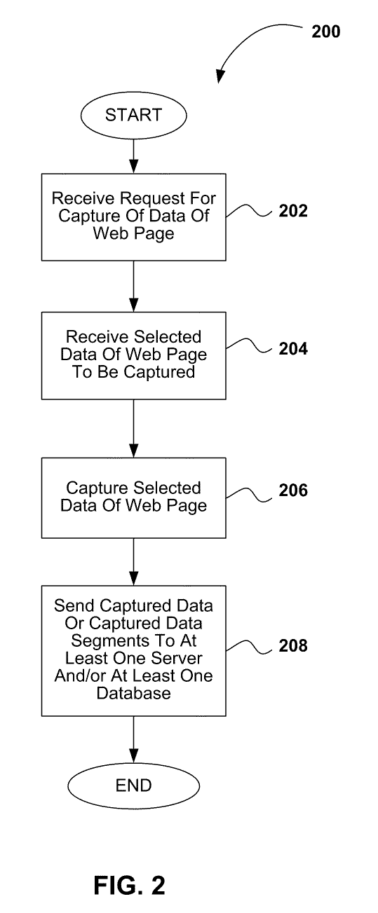

FIG. 2 is a flowchart showing a method 200 for capturing data from a webpage. At step 202, a request to capture data of a webpage is received from a client. At step 204, the selected data of the webpage to be captured is received from the client. At step 206, the selected data of the webpage is captured. The data may be image data and/or metadata. An item of content may be generated from the selected data. Then, at step 208, the captured data or segments of the captured data are sent to at least one server and/or at least one database. Preferably, the captured data or segments of the captured data are stored on a server and/or database, such that the captured data or segments of the captured data can later be retrieved for viewing purposes. In some embodiments, the application captures the selected data from the webpage at step 206 and sends the captured data to the server (e.g., server A 140 and/or server B 142 of FIG. 1) at step 208. For example, a user may make a request to capture data which the server A 140 receives. The server A 140 may direct the application to execute request and the captured data may be received by the server A 140 and/or server B 142 from the user via the application.

Additional steps of the method 200 (not shown) can include receiving user tagging instructions of an item of content, such that tags are associated with the item of content. For example, a portion of a captured image in an item of content or a point in the captured image can be associated with user supplied text or links. Also, the method 200 can include receiving a user description for an item of content and associating the item of content with the user description.

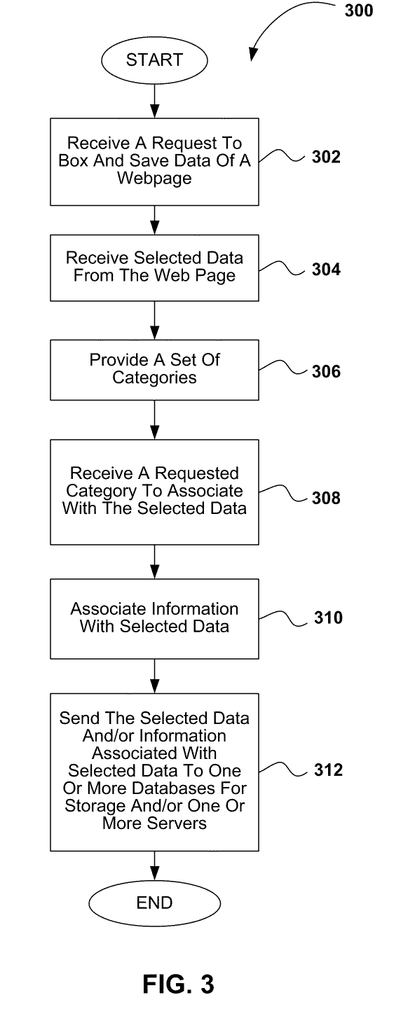

FIG. 3 provides a method 300 to “Box and Save” data. At step 302, a request to “Box and Save” data of a webpage is received. At step 304, the selected data from the webpage is received. Selected data may include, for example, image information from the webpage corresponding to the selected data, and/or metadata associated with the webpage. In some embodiments, the metadata may include non-image data corresponding to the selected data from the webpage. At step 306, a set of categories is provided within the webpage or within a graphic interface provided by the browser application by the application of the present technology. At step 308, a request of a category from the set of categories is received from a user through the application of the present technology or browser application to associate the selected category with the selected data.

At step 310, information is associated with the selected data. In some embodiments, the information includes (but is not limited to) one or more categories, e-mail addresses, metadata, tags, keywords, binary data, and/or textual data. In some embodiments, information includes a location and size of the selected region within the webpage. For example, the location may include location of the captured region on the webpage as defined by parameters, such as height, width and offset from the upper left hand corner of the webpage. The application may display an image of the selected region. At step 312, the selected data and/or the information associated with the selected data is sent to one or more databases. In some embodiments, the data and/or information is transmitted from a client device to one or more databases by application via one or more servers. For example, the image of the selected region may be sent through server A 140 to the database A 150 and the associated information may be sent through the server B 142 to the database B 152 (FIG. 1). An identity of the associated image may be stored with the associated information in the database B 152.

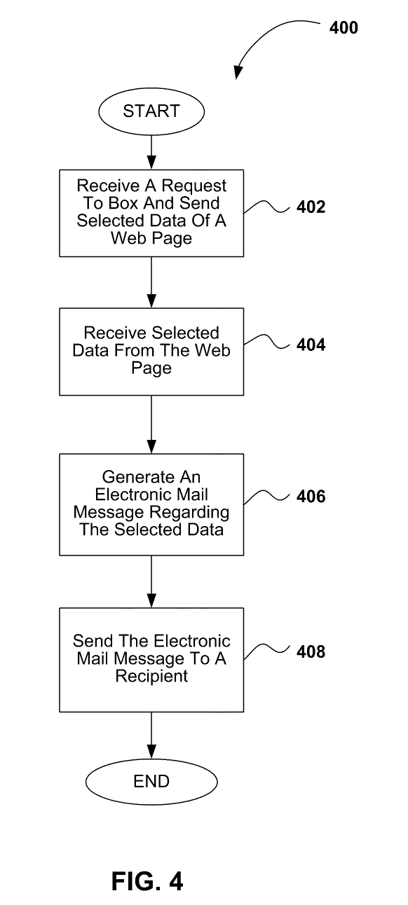

FIG. 4 is a flowchart of an exemplary method 400 to execute a “Box and Send” command. At step 402, a request to “Box and Send” data from a webpage is received. At step 404, selected data from the webpage is received. Webpage data selection may be performed by a user in the manner discussed above with respect to FIG. 3.

At step 406, an electronic mail message is generated. The electronic mail message is configured to provide information regarding the selected data, such as a hyperlink to the selected data. Such a hyperlink may be a URL linking to the webpage that is the source of the captured item of content (such as a web address). The item of content includes, for example, an image and associated information and data as described with regard to “Box and Save” elsewhere herein. In some embodiments, the electronic mail message includes an image or a copy of the item of content. At step 408, the electronic mail message is sent to a recipient identified by the user. For example, the application may provide an interface to a user which allows the user to select a contact or other destination for the message. In some embodiments, the e-mail message is sent to multiple recipients identified by the user.

Additional steps of the method 400 (not shown) include sending the item of content to one or more servers and/or one or more databases, such that the selected data is stored. Also, the method 400 can include associating the item of content to a selected category from the set of categories in the user's account.

When a “Box and Save” command is executed using the present technology, portions of methods 200, 300, 1400, and 1600 may be performed. Likewise, when a “Box and Send” command is executed using the present technology, portions of methods 200, 400, 1400, and 1500 may be performed. The application may be intelligent such that it may distinguish between “Box and Save” actions versus “Box and Send” actions. FIGS. 5-12 show screen shots illustrating various portions of methods 200-400 as may be seen by a user via a display on a computing device while the methods are performed.

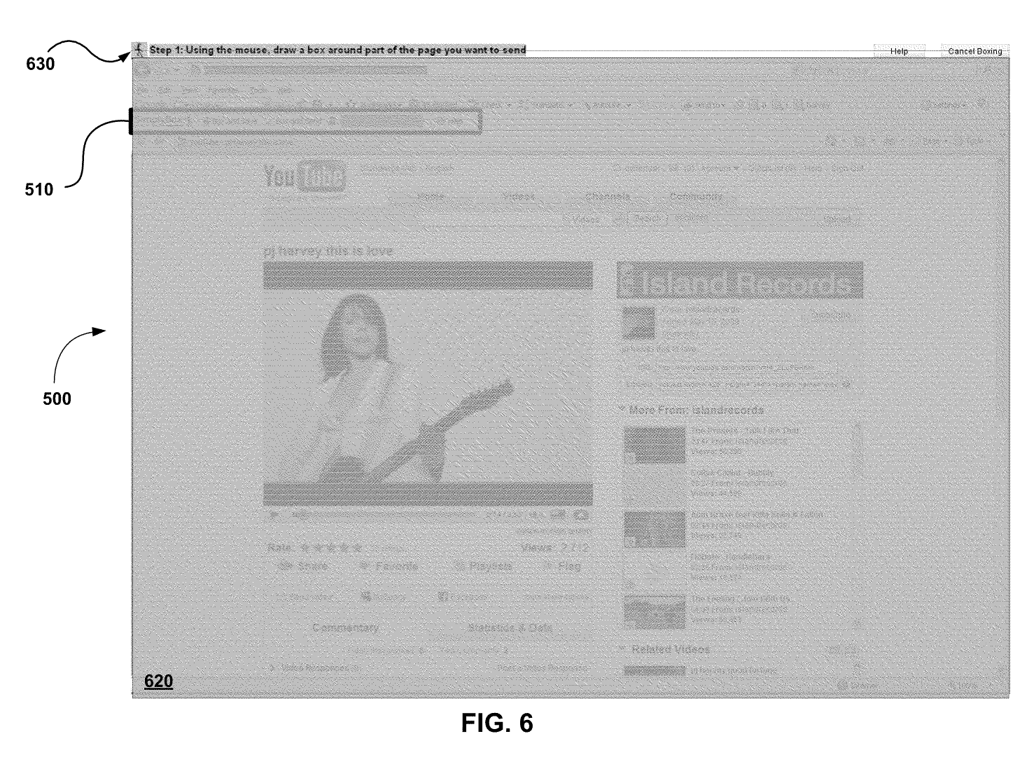

An example of the “Box and Save” process in context of an exemplary application is illustrated in FIGS. 5, 6, and FIG. 7. The “Box and Save” process may be executable by application (such as application 122 or 132 of FIG. 1). For example, FIG. 5 illustrates a webpage 500 from which data may be captured and a toolbar 510 in accordance with embodiments of the invention. When the user clicks the “Box and Save” button in the toolbar 510, the browser is disabled. The application may adjust the image of the webpage as displayed on the computing device. For example, the application may dim or gray the webpage. FIG. 6 illustrates a grayed webpage 620 and toolbar 510 of FIG. 5 in accordance with the methods described in FIGS. 2 and 3. The grayed webpage 620 may form a portion of a region selection overlay that designates which portions of the webpage 500 may be captured. A prompt may provide guidance as to defining a region of the webpage to be saved. An exemplary prompt 630 is shown in FIG. 6.

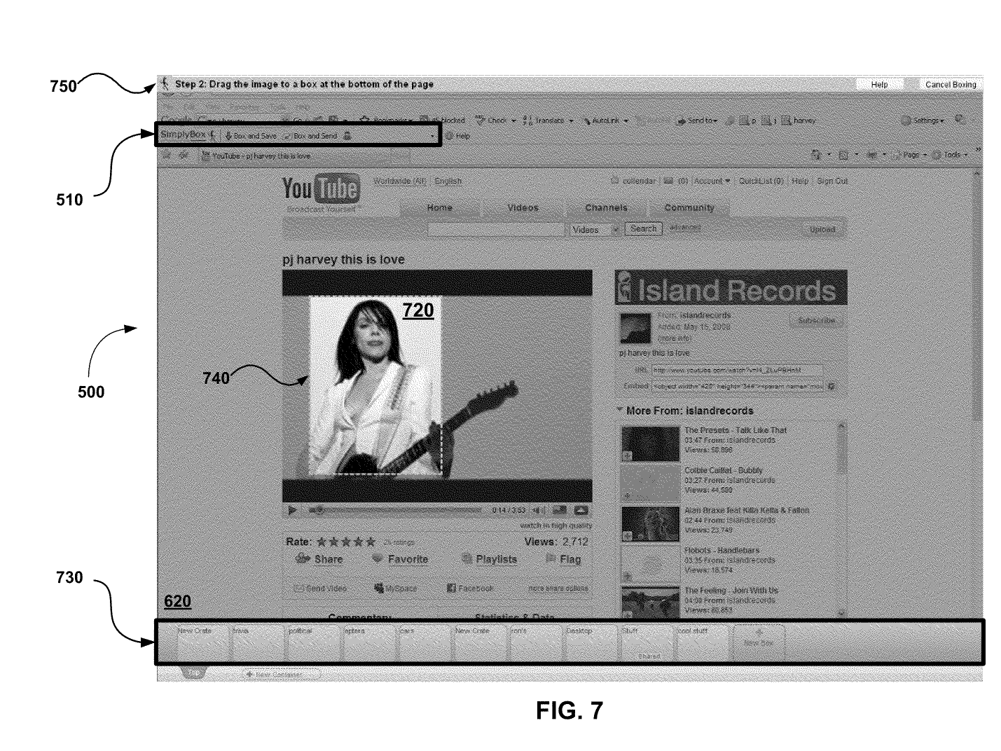

FIG. 7 illustrates a definition of a region of the webpage to be saved 720. Such a definition may be made, for example, by a user input to the computing device moving the cursor and clicking the left mouse button to identify the upper-left corner of an item of content and then releasing the left mouse button when the cursor is on the lower-right corner of the item of content. The item of content is defined by the region of the webpage that the user wants to store and/or share. In some embodiments, a boundary, such as boundary 740, may indicate the extent of data capture for the item of content with respect to the region selection overlay. The application may place the boundary in the display. For example, boundary 740 is a rectangular boundary that indicates that the image to be associated with the item of content is to include the bust of musician P. J. Harvey but not the pins of her guitar, which remain in the grayed portion of webpage 620. Such a boundary may be highlighted on the display of the computing device, which is shown as a dashed rectangle in FIG. 7. In some embodiments, the application highlights the boundary using color, e.g., orange. In order to further distinguish the selected region from the region selection overlay and/or the grayed webpage 620, the selected region may be undimmed. One skilled in the art will recognize that while the selected region in FIG. 7 is illustrated as a rectangle, other shapes may be used, e.g., a circle, oval, ellipse, polygon, amorphous shape, and/or the like. Likewise, other methods to distinguish boundaries of selected data and/or distinguish the selected region from the region selection overlay may be used. In addition, non-image information associated with the image information and/or the webpage may also be associated to the item of content. A prompt may provide guidance as to storing the item of content. An exemplary prompt 750 is illustrated in FIG. 7. In addition, more than one region of selected data may be defined and/or captured from one or more user inputs. As such, more than one region of capture may be defined in one capture, and generated items of content from such a capture may share metadata.

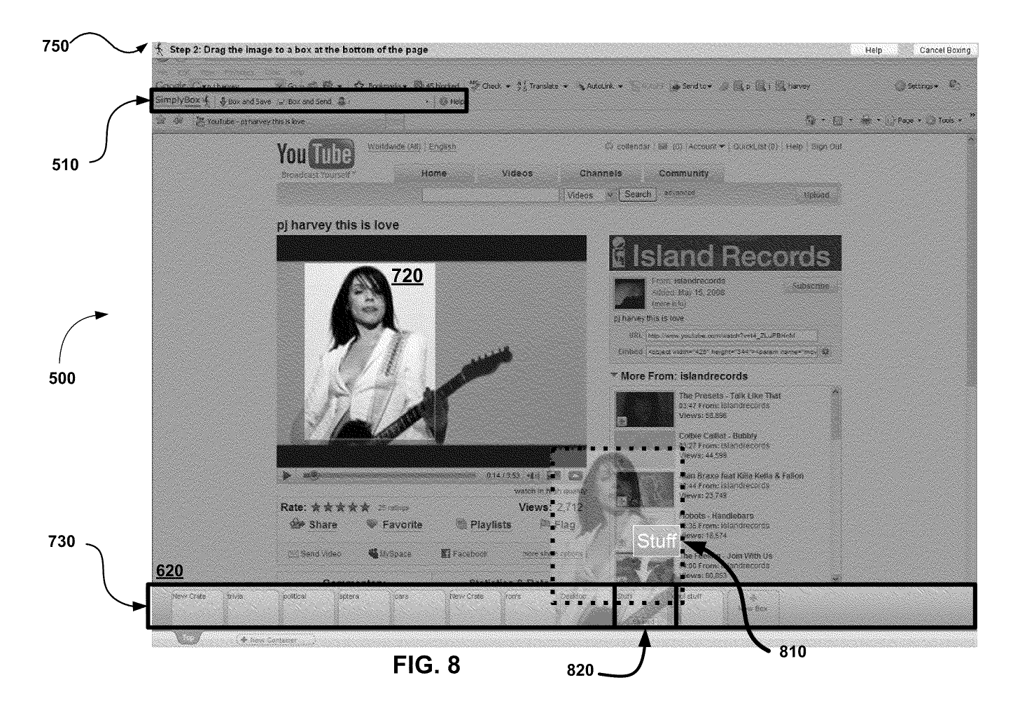

A box bar 730 is illustrated in FIGS. 7 and 8. The item of content may be stored in association with a category in the box bar. Categories in the box bar include but are not limited to boxes and/or containers. Associations to various categories may be made in several ways. In FIG. 8, the dragging of the image of the item of content near the vicinity of the box bar provides further prompts for association in the various categories. An exemplary prompt for association 810 (“Stuff”) is illustrated in FIG. 8. FIG. 8 also shows the association of the item of content to the “Stuff” box 820. Upon release of the mouse button, the item of content defined by the selected region may be saved.

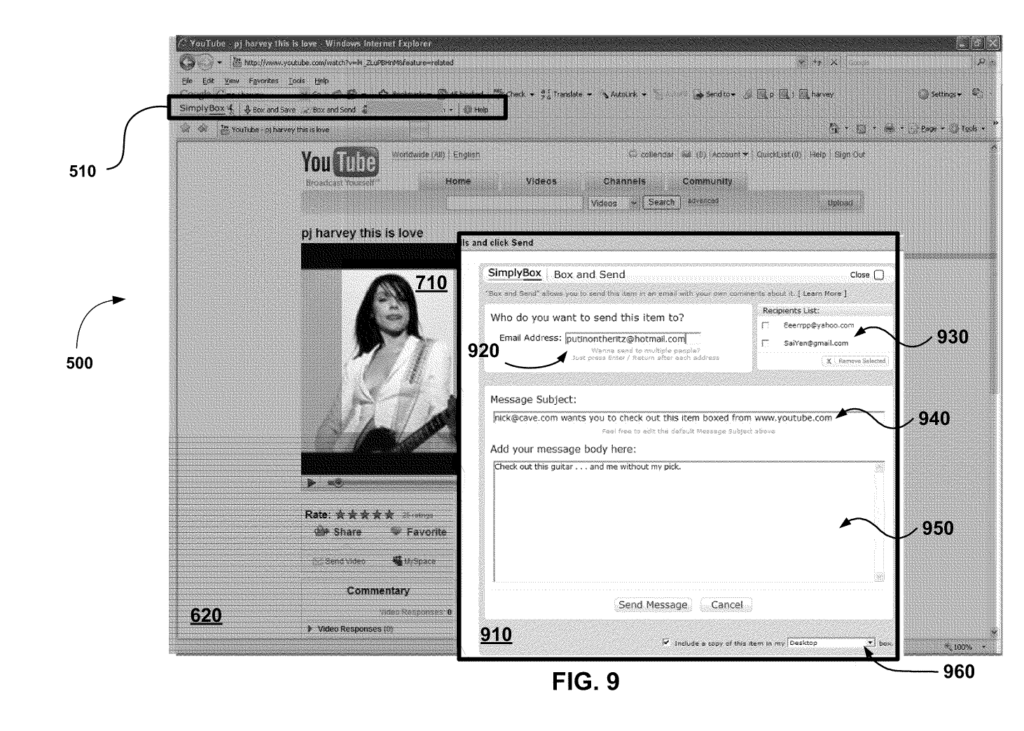

Unlike “Box and Save,” “Box and Send” may not entail definition of a capture region by the dragging of an image into a box bar, such as box bar 730. Instead, once a capture region is defined on the display, a dialog box may be provided to assist in the preparation of a message. A sample dialog box 910 that may be used in the preparation of an e-mail message is illustrated in FIG. 9. Dialog box 910 may include a plurality of fields that request entry of message definitions and/or details. For example, dialog box 910 provides an e-mail address field 920 for entry of one or more recipients of the e-mail. In some embodiments, dialog box 910 may also provide a recipient list 930 from which recipient addresses may be selected. Dialog box 910 may also provide fields that may allow for personalization of the e-mail message, such as subject field 940, and message body field 950. A save selection 960 may also be provided to allow for storage of the item of content in association with a category (e.g., a box and/or container) in a user account. A selection of categories may be provided in save selection 960.

Once a send request is sent (e.g., a “send message” button is clicked) one or more servers, such as servers A 140 and B 142 in FIG. 1, receive a communication. The communication may include image data and the metadata, information and/or keywords associated with the image information, all of which may be included in the message sent to the third party (e.g., the one or more recipients of the generated e-mail). In some embodiments, the third party is a non-user of the application, such as client Z 128 of FIG. 1. The one or more servers may obtain e-mail information, e.g., the content of the e-mail, the intended recipients of the e-mail, the subject of the e-mail, and whether a copy of the image and/or item of content was saved. If the user chooses not to save a copy of the image, the one or more servers may record the information and the image may still be delivered to one or more servers, but the item of content may not be stored in a category as discussed above. This e-mail may then in turn be forwarded to a plurality of recipients who may or may not have application (such as application 122 of FIG. 1) and may or may not be users of the network service.

In some embodiments, the application, such as application 122 in FIG. 1, may provide and manage a dialog box. In some embodiments, the dialog box is rendered in the browser application in a similar manner as the box bar 730 (FIG. 7) discussed above. For instance, the dialog box can be provided in server generated HTML.

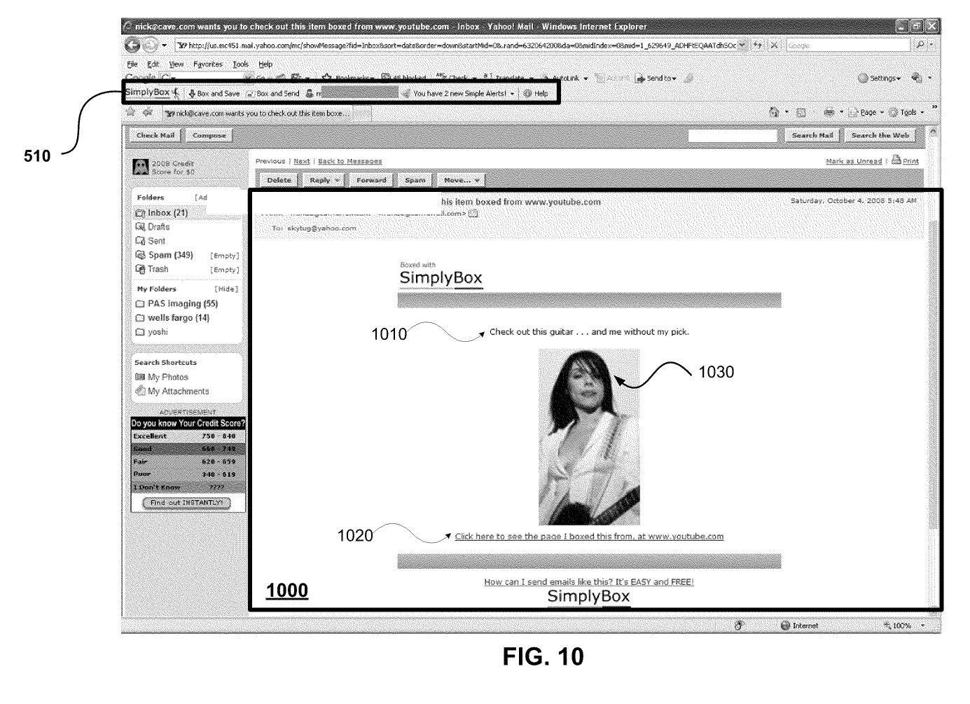

FIG. 10 illustrates an exemplary e-mail message 1000 that may be generated from the content input to dialog box 910. The e-mail message 1000 may be received by a recipient as a result of the execution of a “Box and Save” or a “Box and Send” command. The e-mail message 1000 includes the item of content 1030 and preferably a greeting 1010. When the message is opened, a “visit” button or link may be displayed with the item of content 1030. An exemplary “visit” button or link 1020 is illustrated in FIG. 10. The “visit” button may open the source webpage in the browser for the user. Alternatively, the source webpage may be opened in a new window.

The capturing portions of the “Box and Save” and the “Box and Send” commands may be practiced in several ways. Several methods of defining a region of selection for an item of content may be used. For example, a region of selection may be defined via user input to a touch-sensitive display. In this example, a touch of an upper-left and a lower-right portion may be interpreted as a region of selection. In some embodiments, a region of selection may be defined by another shape, such as a circle, ellipse or rectangle. One of several possible shapes may be specified and the region of selection may be specified according to a method depending on the selected shape. For example, if a circle is selected, the user may define the region by identifying the point at the center of the circle and a point on the perimeter of the circle. In some embodiments, the shape of the region can be modified after it initially defined by selecting and moving points defining the shape.

The selected region of the webpage may be dragged and dropped into an icon representing a category, such as a container and/or a box. Thus, the content of the region may be captured as an item of content using as few as two clicks of the mouse button. For example, in FIG. 8, the selected region 720 is dragged as a transparent duplicate region 810 and dropped onto a box 820 of the box bar 730. The captured image and associated metadata form an item of content which is then associated with that box.

In some embodiments, the selected region of the webpage is captured in an image format such as the graphics interchange format (GIF), tagged image file format (TIFF), portable network graphics (PNG), or Joint Photographics Experts Group (JPEG). In some embodiments, metadata is captured and associated with the captured region of the webpage. The metadata may include, for example, the user name associated with the user's account on the server, the universal resource locator (URL) of the webpage, the date and time the selected region of the webpage was captured, keywords extracted from the webpage, and the location of the captured region on the webpage as defined by parameters, such as height, width and offset from the upper left hand corner of the webpage. In some embodiments, the metadata includes information retrieved about the URL from public tagging services. The metadata may provide for one source URL to be associated with the captured region of the webpage, although in some embodiments more than one URL may be associated with the capture region.

At the time of capturing an item of content, depending on the platform and the needs of the application, data/image manipulation and/or conversion and/or display can be performed by the application. An example of this is an image conversion from a bitmap on Windows to a JPEG. On a Mac, the original image can be captured as a PNG and converted to a JPEG. One skilled in the art will recognize the various data/image manipulation and/or conversion techniques available to the public.

FIGS. 7 and 8 further illustrate how an item of content may be stored in the context of an organizational overlay. Once a region is defined, as shown in FIGS. 6-8, an organizational overlay may be rendered over the region selection overlay. An exemplary organizational overlay is box bar 730 as illustrated in FIGS. 7 and 8. In some embodiments, an application (such as application 122 of FIG. 1) retrieves the organization and content from a server (such as server A 140 and B 142 of FIG. 1), which may store information regarding categories associated with a user account of a network service. In some embodiments, the application may be served by a server coupled to the application. The application may utilize JavaScript and/or HTML as well as other code to render a portion of the organizational overlay and/or to facilitate communications with the server.

In some embodiments, the organization overlay includes a plurality of icons, each representing a category (such as a container or a box). FIG. 7 illustrates a box bar 730 that includes icons, each of which represents a box. In some embodiments, a box is a file that can contain a set of items of content including one or more items of content. A container is a folder that can contain boxes, files and other containers. A hierarchy of containers may be used to organize boxes. The containers and boxes may be named to facilitate the navigation of the hierarchy. This organization is maintained on the server and associated with the user account. Boxes and/or containers can be deleted or added by the user. A recycle bin may be provided, for example, in the application, for this purpose. When a user is introduced to the user account, they may be presented with a default “new box” which acts as an aid to identify the location and purpose of a box in a box bar.

When a region of selection has been received, the application may capture image information as well as non-image data. The application may display any containers and boxes in the selected organizational overlay. In some embodiments, an icon is displayed which causes the organization display to navigate up the hierarchy one level. Using one or more selections in the organization overlay, the hierarchy may be navigated until a box is identified within which to store the captured item of content.

The organizational overlay may be in the form of a box bar, such as box bar 730 (FIG. 7). In some embodiments, the box bar can appear as “floating” such that it can be appear at or near the bottom of the screen when the application is being used as is shown in FIGS. 7 and 8. It may disappear when the application is not being used or when the user has navigated away from the webpage where a capture of data has already occurred. Containers may be organized in the box bar as tabs in the box bar, whereas boxes may be shown as squares within the tabs of the containers.

Items of content may be transferred, duplicated, and/or otherwise manipulated within the organizational overlay. For example, a user may “re-box” an existing item of content or a portion of an existing item of content. The “re-boxed” data may then be stored as a new item of content. Similarly, the items of content may be “cut” or “copied” from one category and “pasted” to another. User input to modify the images may also be accepted.

The box bar may be located at the bottom of an adjusted image within a webpage, for example, a dimmed or grayed region of the webpage, as illustrated in FIG. 7 by the box bar 730 at the bottom of grayed webpage 620. Alternatively, the box bar may be found at the bottom of the entire screen, or at some other location with a graphic interface or content page provided by a browser application.

The box bar may be provided or “drawn” in different ways. In some embodiments, the box bar may contain some but not all the boxes associated with a user account with the network service. In some embodiments, the box bar may contain all the boxes associated with the user account. In some embodiments, the box bar may contain boxes other than those associated with the user account.

The box bar may be generated such that it does not require the current application to communicate with server to request information about boxes associated with a user's account. For instance, an application may have the information or request at regular intervals the information to determine the contents of the box bar, including but not limited to the identification of boxes themselves. The application may maintain the client side information prior to or at the time of performing a “Box and Save” or a “Box and Send” action initiated by the user by clicking the appropriate button on the toolbar.

In other words, an item of content may be generated from a user's click and drag (from the region of selection), all of which may be handled by the application. The dragging of an image or data into a box indicates to the application that an association is to be made between the image and/or data and the selected box. The association may include metadata and/or textual data, including the URL, keywords, tag and/or description information, regardless of whether the user provided this information to the application or whether it is done automatically by the application.

Once the association of information with a selected data occurs, the association may be sent to one or more servers for storage in a database coupled to the one or more servers, as discussed in the context of FIG. 1. In some embodiments, binary image data or selected captured data may be delivered to one server, whereas association and/or metadata information about the binary image or selected captured data may be sent to a second server. In some embodiments, a key may be required from one server to another to permit the delivery of data to the server that requires the key for saving the binary data. Without the key, the requested server may reject the request to save the image or binary data as a security precaution, such that a user may be required to obtain permission to save images. One skilled in the art can appreciate that such partitioning of the data from the association and/or metadata information does not have to occur between two or more servers. Binary image data or selected captured data can be stored along with the association and/or metadata information on the same server.

After the item of content is dropped into a box, the application may remove the organization overlay and the region selection overlay, thereby restoring the normal view of the webpage, as shown in FIG. 5 from the dimmed or grayed webpage as shown in FIG. 6. When a region selection overlay is rendered as shown in FIG. 6, normal browser activity may be suppressed. For example, navigation away from the webpage from which content is captured may be suppressed. Upon association of the item of content to a category, normal activity of the browser may be restored. Other regions may then be captured from that webpage or other webpages by repeating the process above one or more times.

Upon association of the item of content, navigation of the Web by a user may continue. The above processes may be repeated for any subsequent webpage visited via the processes discussed above. For example, a user of the network service may save items of content in a box associated with “cars,” other items of content in a box associated with “vacations” and yet other items of content with a box associated with “work,” regardless of the order in which the user captures the content from the Web. Thus, the process of capturing content may be done without significantly burdening the user's web surfing experience.

The present technology, for example, when implemented by a network service and/or an application (such as applications 122 and 126 of FIG. 1) also allows for reverse traffic. When a user captures an item of content (e.g., an item of content associated with the selected region 720 of FIG. 7), the network service allows a return to the site of origin of the selected region 720 at a later time. The source of origin of an item of content saved from the selected region 720 may include the URL of the webpage 500 from where the image was captured. In some embodiments if the content of the webpage 500 has been changed or updated after the item of content was captured and the URL may direct the user to a webpage reflecting currently posted content which is different from the captured content. In order to access the source of origin, the user may select the item of content in the network service and may be presented with a URL link that was associated to the webpage 500 at the time of capture. The URL link is stored in a database coupled to one or more servers, preferably at the time of capture.

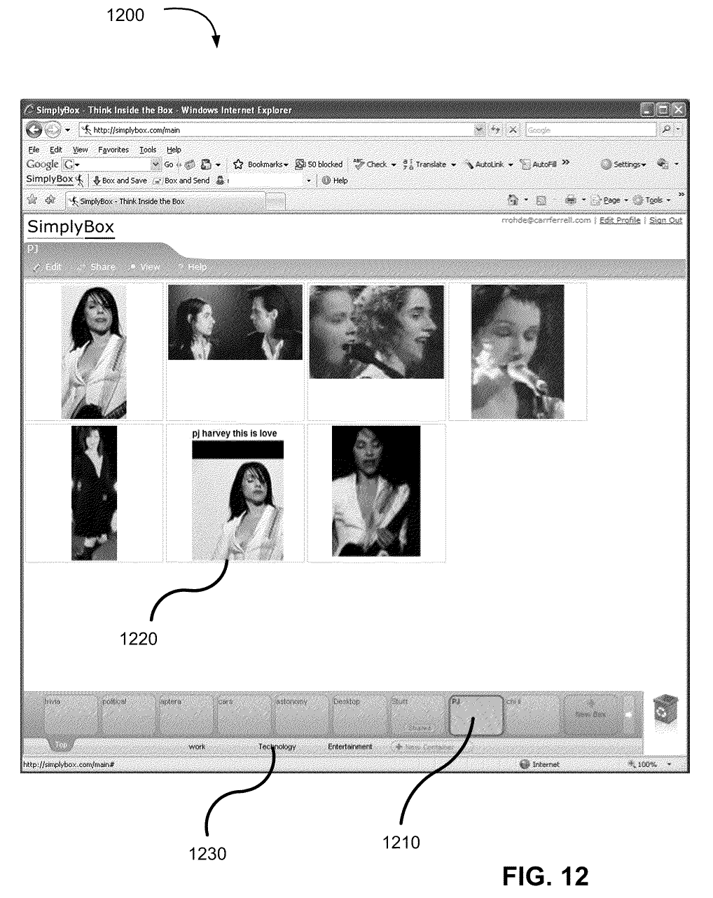

A user may access items, boxes or containers via box bar 730 or by accessing a webpage associated with the network service. An exemplary associated webpage is illustrated and described further in the context of FIG. 12. Within a box, one or more captured items of content may be displayed. This box may be accessed through the application. In some embodiments, the display may include just the captured image. In other embodiments, some or all of the metadata associated with each image may be displayed with that image.

Items of content may be arranged in the boxes according to the user preferences. As such, the following discussion regarding styles of organization of the items of content within the boxes may be applied to any type of box, such as the “Public” box and the “Shared” box. Any combination of the following organizations may be utilized. Styles of organization may be provided by the application (such as application 122 and/or 132) via a menu (e.g., a drop-down menu).

In some embodiments, the items of content may be displayed in a grid style of organization in which the content is displayed in rows and columns. A grid-view organization within a box is illustrated in FIG. 12. The items of content may be rearranged by dragging a selected item of content into a position such that it is inserted into a particular position in the grid. The position stored for each of the items of content in the grid view may be represented by a column and row number.

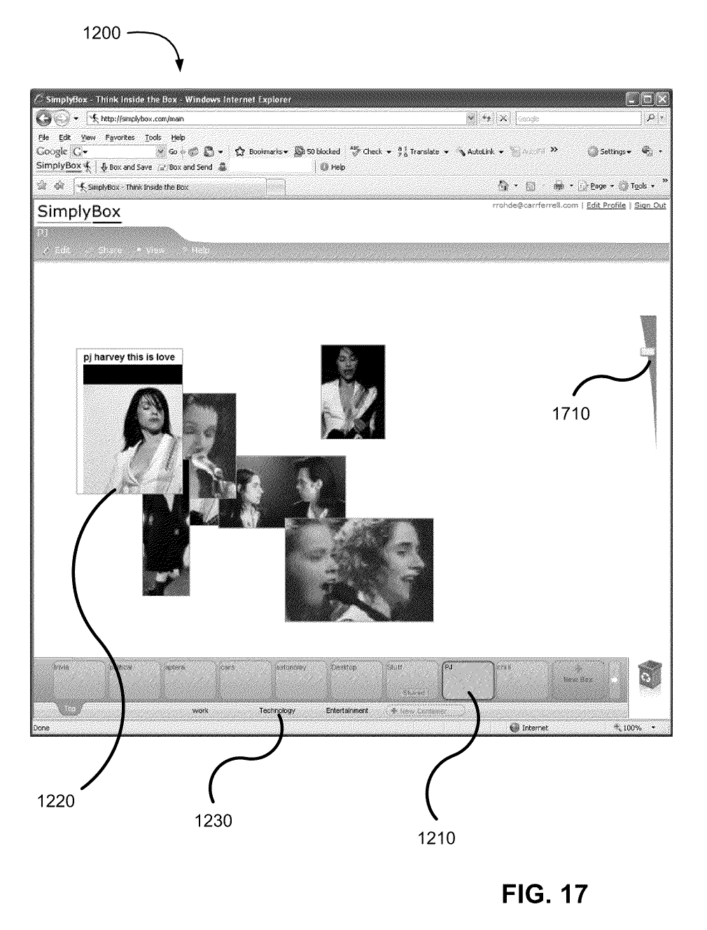

The captured items of content (such as 1220 in FIG. 17) may be displayed in a free-form style of organization (FIG. 17) such that the items of content may be dragged and dropped to any position in a virtual space for that box (1210 in FIG. 17). In some embodiments, a presentation of the items of content may overlap each other such that some items of content are completely or partially covered by one or more other items of content. There may be a priority for displaying overlapping items of content (“z-position”) such that the more-recently moved items of content are displayed over less-recently moved items of content. A user may specify a display priority. The position of each of the item of content in the virtual space may be stored and associated with that item of content so that the next time the contents of the box are displayed, each of the items of content is at the same location it was left at within the virtual space. This position may include an indication of horizontal and vertical position as well as z-position. Further, a user may use a slider 1710 to expand or contract the relative size of all items of content.

In some embodiments, the virtual space is within the display area. In other embodiments, the display area is a window into a portion of the virtual space and this window can be moved to view other portions of the virtual space.

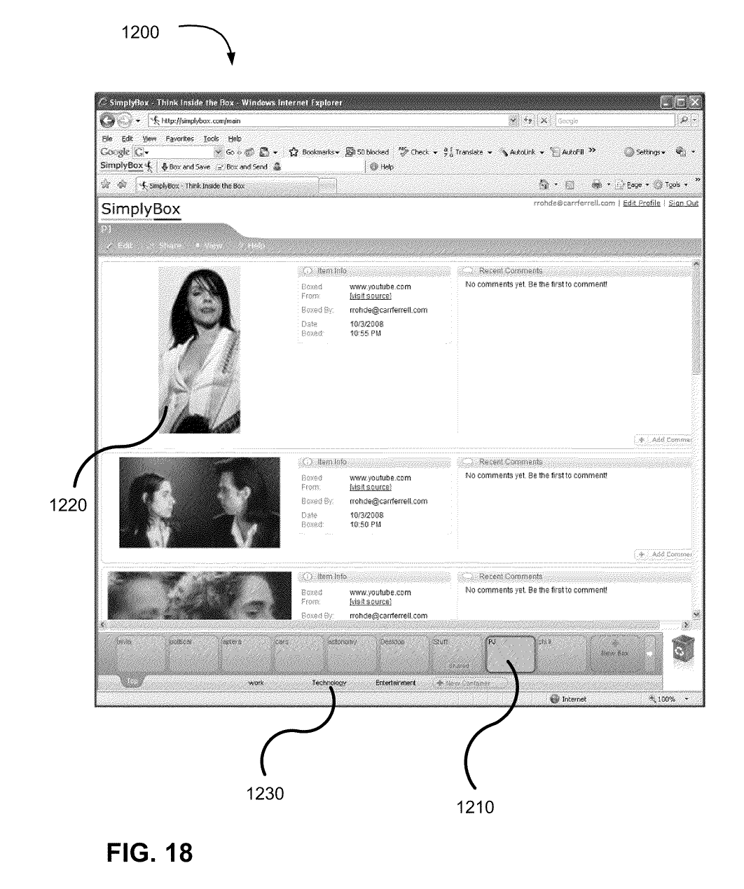

In some embodiments, the items of content (such as 1220) may be displayed in a list style of organization or list view (FIG. 18) in which the items of content are arranged in a list by the application. As shown in FIG. 18, the list may be a vertical one. The items of content may be rearranged by dragging a selected item of content into a position such that it is inserted into a particular position in the list. The position stored for each of the items of content in list view may be an index in the list.

Captured content may be shared in several ways among users of the application and/or network service. Thus, the source content from a website may be shared in user-defined fragments of the source website. This method of sharing may be referred to as fragmentation. Fragmentation allows for the website content to be brought to a user and to anyone they may share the item of content, instead of requiring a visit to the website in order to learn of the source content. As such, the item of content may be virally distributed. For example, a user of the network service (such as a user of application 122, 126, or 132 in FIG. 1) may promote the viral distribution of content by sharing an e-mail, a box and/or a container with an influencer in a social network.

A user may perform a “Box and Send” command to directly share an item of content captured by the application. In some embodiments, the user may directly share an item of content to other users. Users may also share content with non-users by generating a URL link or an RSS link and incorporating the link in the e-mail of step 406 (FIG. 4). In some embodiments, the e-mail includes the captured item of content which may serve as the link as part of the body of the e-mail. A user may select the e-mail addresses of other network service users or non-users with whom to share the content. Alternatively, the e-mail address is retrieved from an address book or similar list of e-mail addresses, such as recipient list 930. Such an e-mail may, in turn, be forwarded to a plurality of recipients.

Content may also be shared via execution of a “Box and Save” command. Saving includes storing the item of content on a computer readable medium such as those discussed in the context of FIG. 1. For instance, the item of content may be stored on a server, in a data base, on a hard drive, in memory and/or the like. In some embodiments, the item of content is stored in association with a predetermined box. As discussed elsewhere herein, a box may be a collection of items of content. Examples of a box include a folder, a file, a storage medium, an account, a database, and/or the like. In some embodiments, a user account with the network service of the present technology may include multiple boxes. For example, a user of the network service may establish multiple boxes in the user account and group stored items of content in various boxes according to one or more user preferences. In some embodiments, a box is shared with other users and/or non-users of the network service. Thus, an item of content in the shared box may be shared with another user and/or non-user using as few as two clicks of the mouse button in a “Box and Save” command.

In some embodiments, boxes that appear on the box bar may include a “Shared” tag to indicate that the content in the tagged box is shared. Such boxes may also be referred to as “Shared” boxes. An exemplary “Shared” box is illustrated in box 820 of FIG. 8. When a user clicks on the “Box and Save” button on toolbar 510, boxes that appear on the box bar may include a “Shared” tag. As such, the “Box and Save” action may be equivalent capturing, saving, and sharing actions combined. This action may be handled by one or more servers such as servers A 140 and/or server B 142 of FIG. 1.

The user that captured the item of content (i.e. an owner of the item of content) may share containers and boxes. The owner may share an entire box or a single item, for example, via invitation to view the same. The owner may share an item of content directly from the application 122 or 126 by selecting an item of content within a box and selecting “Box and Save” or “Box and Send.” In some embodiments, users of the network service are able to access items of content related to the captured data through a “Shared” box or a “Public” box. A “Shared” box may be available for viewing by the network service users and non-users designated on a list depending on one or more owner preferences. A “Public” box, in contrast, may be available to a general list, or even to the general public. Information related to a “Shared” box and/or item of content may be available for viewing by all the invited network service users and non-users via a display box. A similar display box with corresponding information may also be available for the “Public” box. This information may include when the item of content was captured, the owner of the item of content, and/or details related to activity within a box related to the item of content. “Public” boxes may be accessible to the general public via a URL or RSS link.

“Shared” boxes and “Public” boxes may have one or more owners who may be allowed to perform “Box and Save” and/or “Box and Send” operations. This may be accomplished by specifying permissions associated with the containers and boxes on the server, which may then grant access based on those permissions. The box owner may manually input an e-mail address of a person to share the box with. In some embodiments, an entered e-mail address of a network service user may be recognized by the application. Alternatively, the box owner may designate a delegate who may specify the permissions for the box.

In some embodiments, the owner may specify that even non-users of the network service may access the content. The owner can also specify users that can access that content and access privileges, by specifying a delegate and/or by specifying classifications of groups of users, such as “family” or “friends.” Furthermore, in some cases the owner can specify one or more administrators that also have permission control capabilities with regard to the items of content captured by the owner.

The accessibility of the content may be controlled for particular users and/or groups of users. Furthermore, the permissions to access content may be controlled for a particular box, particular container, or groups of containers and/or boxes.

For example, the owner may grant permission to read and add items of content to users in a group for “family,” read-only permission to users a group for “friends,” and permission to delete items of content to a delegate, who may or may not be in the “family” or “friends” group.

In some cases, the view (free-form, list and/or grid) of a box and the position of each item of content within that box is determined by the owner. The owner may determine the items of content to be the same size or of different sizes according to preferences of the owner. Owner preferences can include definition of identifiers in a website. For instance, the owner can capture a portion, title, and/or frame of a video or document, and any other nugget of information that the owner wishes to capture. In some embodiments, this invention allows for the owner to determine the building blocks of data capture and is not limited to conventional definitions such as files, folders and webpages. For example, the present embodiments provide a visual organization of captured data tailored to the owner's preferences. A user may also sort the items of content into piles or groups according to user preferences, thereby enhancing the visual experience. Alternatively, the user may link one or more items of content together. In other embodiments, the organization may be determined by the last user that modified the view in a box or position of an item of content within the box. In yet other embodiments, the view organization and position is maintained independently for each user that has access to a particular box. In some embodiments, non-users may also be granted permission to access a particular box and determine the organization and position(s) of the items of content.

In some embodiments, two or more users may view a shared box simultaneously. The permissions for a shared box may be established such that one or more other users can view the box. In some cases, the permissions for a shared box may be established such that more than one user can also add items of content to the box. Thus, when items of content are modified in a shared box by one of the users that have permission to do so, the users that can view that shared box can see that change. In such embodiments, a list of users currently accessing the box may be made available to the owner and/or users.

In some embodiments, a server may detect changes within boxes and/or containers and push items of content to sharing users so that the display of each of the viewing users is updated in response to the addition or modification of items of content. For example, any current sharing user may move an item of content in a box to a new position within the box. The move will be shown and the item of content will appear in the new position in the display of the box for each of the other sharing users. Alternatively, the new items of content may appear in the shared box to the second user upon a refresh of the browser window. The refresh may be initiated automatically by the browser or by clicking a refresh button in the browser window.

In some embodiments, permissions and/or settings may be represented by a “settings” icon. The settings icon (not shown) may be dragged on top of an item of content and attach additional settings features. Thus, actions may be chained together. For example, a settings icon representing a setting configured to make an item “publicly editable” is dragged and dropped on top of the item of the content. The item may then be dragged and dropped into a box. In some embodiments, the settings icon is attached to the item and the two are dragged together to the box. Alternatively, the settings icon is dragged and dropped into the box without being attached to item to set the permissions of all the captured content in the box to “publicly editable.” In some embodiments, the settings icon is pre-defined by the user.

In some embodiments, sharing rules and/or permissions are stored on one or more servers, such as servers A 140 and B 142 as illustrated in FIG. 1. The application may have no direct knowledge or data regarding the sharing statuses of any other users. For example, application 122 of FIG. 1 may have no access to a sharing status for application 126. The application may ensure that a “Shared” tag may be associated and/or visible to users such that it is evident which box or boxes are shared by two or more users. Further, in some embodiments, the database (such as databases A 150 and B 152) may have entries for each user who has access to a specific box. If one user eliminates access of a box to another user, the action results in a removal of an entry in the database that allowed for shared access. The user interface for specifying such permissions may be accomplished by a dialog box on a server. An exemplary dialog box is illustrated and discussed further in the context of FIG. 12.

A note or a comment may be associated with an item of content, e.g. an image in an item of content. In one embodiment, a user selects the image by clicking on a point in the image. An icon and/or a note box may be displayed proximate point where a user may enter a note into the note box. The note and the icon may be subsequently displayed with the image. The note may be placed anywhere on the image. In various embodiments, the note may include text, image, highlighting, a link, and/or the like. Text included in item may similarly be annotated. For example, text may be highlighted for emphasis. Permissions may also be used to control which users can see notes and which users can add notes to an item.

An alert may be sent in response to the sharing of an item of content. FIG. 11 illustrates details of an alert 1110 provided in the toolbar 510 of FIG. 5. Upon receipt of the alert 1110, a user may click on the alert and be redirected to the box and/or item of content that triggered the alert 1110. Exemplary alerts may include notifications of sharing of boxes by other users, or the adding of a comment to the box and/or item of content. In some embodiments, the alerts are stored on one or more servers and provided in toolbar 510 in real-time or near real-time. The action of a user or owner dragging and dropping an image or item of content into the shared box may trigger the sending of an alert to other users that have access to the shared box.

Alerts may be sent to users of the network service when an owner or non-owner generates and shares an item of content. Alerts may be sent to an owner or a non-owner upon the addition of a comment from one or more users according to the permissions discussed herein. In some embodiments, an alert may be sent to each recipient on an e-mail list who is a user of the network service. In the event that the owner shares content with users and non-users of a network service, the users may receive alerts. Non-users of the network service may receive an e-mail such as e-mail message 1000 as illustrated in FIG. 10. The non-user may access the content through a link, such as an exemplary link 1020 as illustrated in FIG. 10.

FIG. 12 illustrates a host application 1200 for accessing boxes 1210 and items of content 1220 in accordance with embodiments of the invention. The box 1210 includes an array of items of content (e.g., item of content 1220). A list of containers is illustrated across the bottom of the box 1210. A container 1230 is an example of a container in the list. The container 1230 may contain one or more boxes (such as boxes related to “Technology” as indicated by the name of the container 1230 as shown in FIG. 12). In some embodiments, code executed by the browser provides a webpage including a host application 1200 that allows the user to (1) manage the organization of the items of content 1220, (2) manage permissions for individual containers 1230 and boxes 1210 or groups of containers 1230 and/or boxes 1210, and (3) define and manage groups of users that may be used for managing permissions and distribution of items of content 1220.

The captured image, associated metadata and an indication of the associated box is uploaded to the server and made available to other users according to the sharing permissions granted. A non-user of the network service may have the same permissions as a user of the network service with respect to a shared item of content or a shared box. For example, the owner of the host application 1200 of FIG. 12 may make the box 1210 accessible to non-users. In some embodiments, the non-user can add a note to the item of content 1220 but cannot delete the item of content 1220 or add or new items of content to the box 1210 of the host application 1200. These privileges may be customized by a user preference according to one or more rules.

In some embodiments, a user may access the host application 1200 from a mobile device (e.g., a cell phone, a PDA, an iPhone, and/or the like). Some or all of the functionality of the host application 1200 may be retained when accessed via the mobile device. In various embodiments, functionality includes capture, box and send, box and save, display of items of content, sharing of items of content, attaching notes to items of content, setting permissions, organizing boxes, sharing boxes, accessing a box in another box, taking pictures using a camera in a cell phone, and other functions described above. A picture taken by a cell phone or a PDA may also be treated as an item of content 1220 and stored in the box 1210.

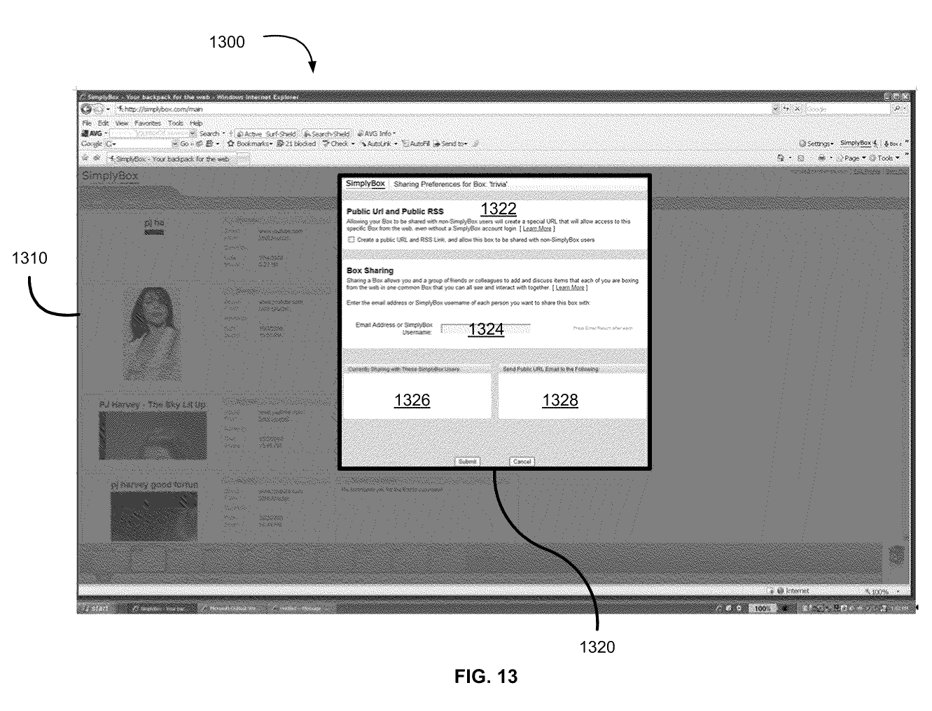

FIG. 13 illustrates a host application webpage 1300 including a grayed out box 1310 and a dialog box 1320 for activating sharing in accordance with embodiments of the invention. The dialog box 1320 may be displayed by a host application in a webpage, such as host application webpage 1300. The dialog box can show a “share this box” dialog which allows the user to activate or deactivate access of a user to a box. A create URL field 1322 of the dialog box 1320 may be provided for designating the grayed out box 1310 as a “public box.” Selection of the create URL field 1322 may provide a URL and/or RSS link to share the grayed out box 1310 over the Web. A box sharing field 1324 may be provided for adding a new user to a list of sharing users. Upon sharing box 1310, a visible “Shared” tag may be added to box 1310 thereby indicating that it is a “Shared” box. A list of users with whom box 1310 is shared may be provided in list 1326. An e-mail recipient list 1328 for the URL and/RSS link may be provided to display the same.

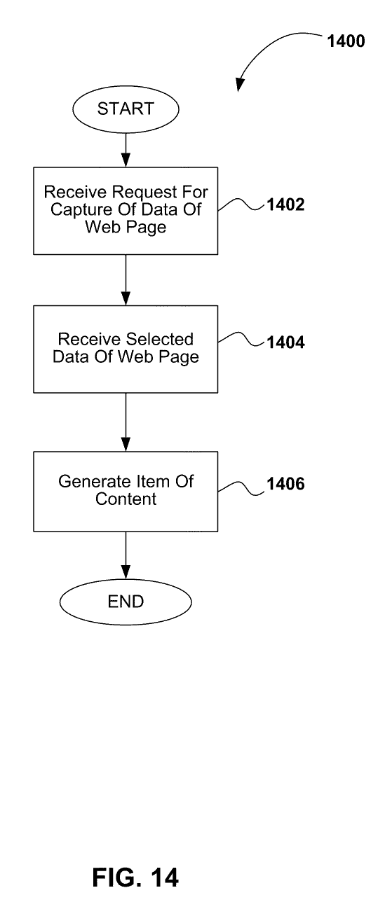

FIG. 14 is a flowchart illustrating a method 1400 for capturing data from a webpage. At step 1402, a request to capture data of the webpage is received. The capture request may be, for example, a “Box and Save” request or a “Box and Send” request from a user input to a computing device. At step 1404, data from a selected region of the webpage is received. This data may correspond to image information used to construct an image to represent an item of content, and/or non image data, which may include, for example, metadata and/or data corresponding to the webpage or the selected region of the webpage. At step 1406, an item of content is generated. Generating an item of content may include sending image data of the selected data to a first server, and storing the image data to a first database coupled to the first server. Generating an item of content may also include sending non-image data of the selected data to a second server, and storing the non-image data to a second database coupled to the second server. In some embodiments, image data and non-image data may be sent to the same server. In some embodiments, image data and non-image data may be stored in the same database. The item of content may have associated to it an image corresponding to the image information received in step 1404 and/or the metadata from step 1404. While steps 1402-1406 are illustrated in FIG. 14, fewer or more steps may fall within the scope of various embodiments.

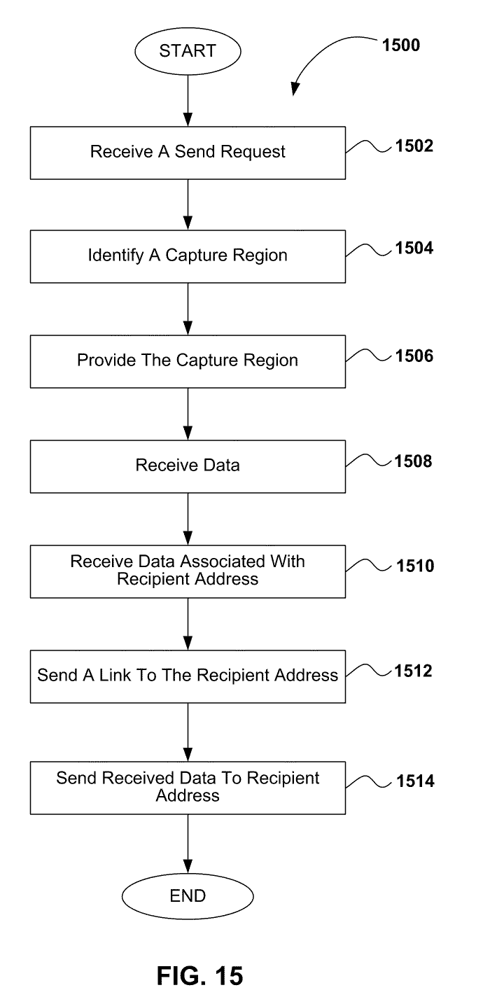

FIG. 15 is a flowchart illustrating a method 1500 for capturing and sending data. At step 1502, a send request is received. The send request may be received from a user input to a computing device. At step 1504, a capture region within a webpage displayed on the display of a user device is identified. At step 1506, the capture region is provided for displaying on the display. At step 1508, data based on the capture region is received. Such received data may include image data and non-image data that correspond to the capture region. At step 1510, data associated with a recipient address is received. At step 1512, a link associated with the webpage from which the data was captured is sent to the address. At step 1514, the received data is sent to the recipient address. While steps 1502-1514 are illustrated in FIG. 15, fewer or more steps may fall within the scope of various embodiments.

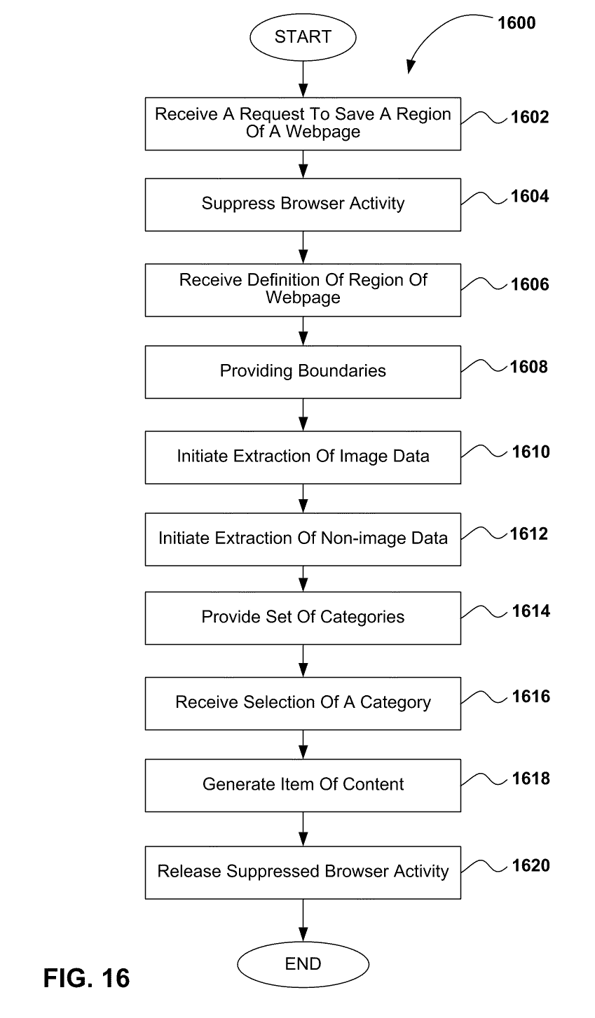

FIG. 16 illustrates a method 1600 for saving a region of a webpage displayed by a browser. At step 1602, a request to save a region of the webpage is received. At step 1604, browser activity is suppressed. The webpage may be dimmed or grayed out indicating which portions of the webpage may be captured. At step 1606, a definition of a region of the webpage to be saved is received. Such a definition may be received (e.g., via a user input to a computing device). At step 1608, one or more boundaries of the defined region are provided. The defined region, including the one or more boundaries, may be indicated to the user via the display of the computing device on the region selection overlay. At step 1610, extraction of image data from the defined region is initiated. At step 1612, extraction of non-image data from the defined region is initiated. At step 1614, a set of categories is provided. The categories may be displayed via the display of the computing device. At step 1616, a selection of a category is received. The selection may be received from a computing device, and may indicate a selection on behalf of a user. In some embodiments, the region selection overlay may be removed (not shown). At step 1618, an item of content is generated. The image information and/or non-image data may be associated to the item of content. At step 1620, suppression of browser activity is released. Normal function of the browser may be restored, and navigation may continue. While steps 1602-1620 are illustrated in FIG. 16, fewer or more steps may fall within the scope of various embodiments.

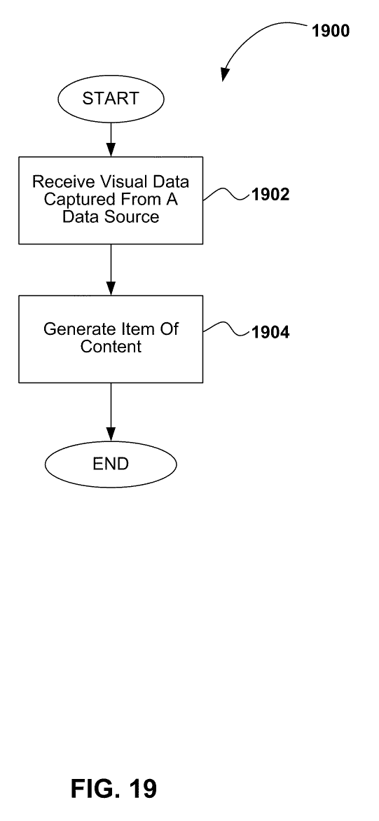

FIG. 19 illustrates a method 1900 for saving visual data captured from a data source. At step 1902, visual data captured from a data source is received via a network from a computing device coupled to the network. The visual data includes image data and non-image data. At step 1904, an item of content is generated based on the selected visual data from the data source for storage in a database coupled to the network.

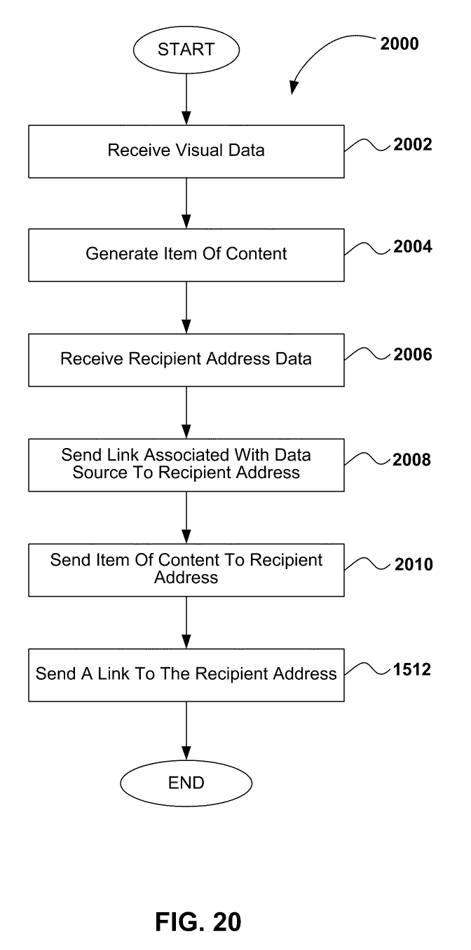

FIG. 20 illustrates a method 2000 for sharing visual data from a data source. At step 2002, visual data is received from a computing device coupled to the network. The computing device has a display. At step 2004, an item of content is generated based on the visual data received from the computing device. At step 2006, data associated with a recipient address from a second user input to the computing device is received. At step 2008, a link associated with the data source is sent to the recipient address via one or more web servers coupled to the network. At step 2010, the generated item of content is sent to the recipient address via the one or more web servers.

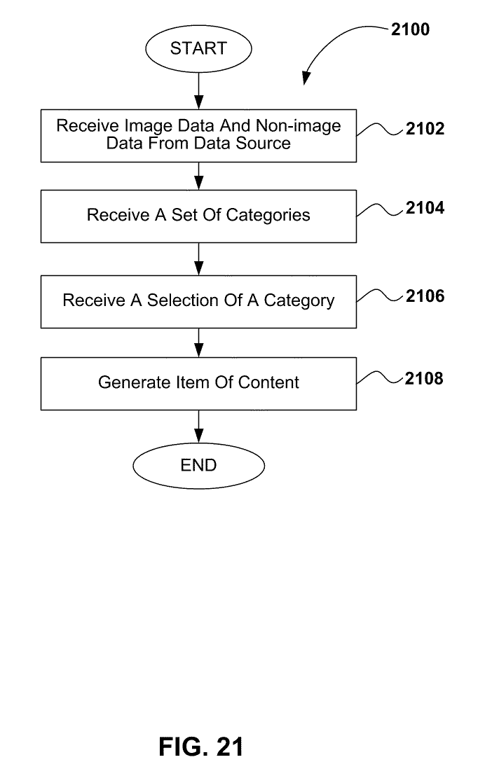

FIG. 21 illustrates a method 2100 saving image data and non-image data from a data source. The data source is displayed on a display of a computing device by a browser. At step 2102, image data and non-image data is received from the data source via a network. The computing device coupled to the network. At step 2104, a set of categories is received from a server coupled to the network and provided to the computing device. At step 2106, a selection of a category from the set of categories provided by the server is received from the computing device. At step 2108, an item of content is generated for storage in a database coupled to the network. The item of content is generated based on the image data and non-image data from the data source.

Further embodiments of the invention are illustrated in U.S. Provisional Patent Application Ser. No. 61/061,520 filed on Jun. 13, 2008 and entitled “System and Method for Capturing and Visually Organizing Screen Shot Segments,” U.S. Provisional Patent Application Ser. No. 61/076,586 filed on Jun. 27, 2008, entitled “Capturing and Sharing Screen Segments,” U.S. Provisional Patent Application Ser. No. 61/095,925 filed on Sep. 10, 2008, entitled “Methods and Media for Embedded Content,” and U.S. Patent Application Ser. No. 61/102,858 filed on Oct. 5, 2008, entitled “Systems and Methods for Capturing, Organizing and Sharing Data.” Note that the term “crate” as used in Appendices A-E is “box” as used in the detailed description of the present application. The term “box” as used in Appendices A-E is “item” as used in the detailed description of the present application. The term “palette” as used in Appendices A-E is the term “container” as used in the detailed description of the present application.

The above-described functions and/or methods may include instructions that are stored on storage media. The instructions can be retrieved and executed by a processor. Some examples of instructions are software, program code, and firmware. Some examples of storage media are memory devices, tape, disks, integrated circuits, and servers. The instructions are operational when executed by the processor to direct the processor to operate in accord with the invention. Those skilled in the art are familiar with instructions, processor(s), and storage media.

Upon reading this paper, it will become apparent to one skilled in the art that various modifications may be made to the systems, methods, and media disclosed herein without departing from the scope of the disclosure. As such, this disclosure is not to be interpreted in a limiting sense but as a basis for support of the appended claims.

1. A computer-readable storage medium having embodied thereon a program, the program being executable by a computer to perform a method for generating an item of content, the method comprising:
receiving a request to capture visual data from a data source;
receiving selected visual data from data source; and
generating an item of content based on the visual data.

2. The computer-readable storage medium of claim 1, wherein generating an item of content comprises:
sending image information of the selected visual data to a first server; and
storing the image information in a first database coupled to the first server.

3. The computer-readable storage medium of claim 2, wherein generating an item of content further comprises:
sending non-image data of the selected visual data to a second server; and
storing the non-image data in a second database coupled to the second server.

4. The computer-readable storage medium of claim 3, wherein generating an item of content further comprises:
associating the image information and the non-image data; and
storing the association in one of the first database, the second database, and any combination thereof.

5. The computer-readable storage medium of claim 1, wherein receiving the selected visual data comprises receiving data from a selected region of the visual data.

6. The computer-readable storage medium of claim 1, wherein generating an item of content occurs while accessing the data source of the selected visual data.

7. The computer-readable storage medium of claim 1, further comprising:
providing a set of categories;
receiving a selection of a category from the set of categories; and
associating the selected category with the selected visual data.

8. The computer-readable storage medium of claim 5, further comprising receiving two sets of coordinates which identify the selected region of the visual data.

9. The computer-readable storage medium of claim 2, further comprising:
receiving a text string for an image associated with the image information; and
associating the text string with the image.

10. The computer-readable storage medium of claim 7, further comprising displaying the image information in association with the selected category.

11. The computer-readable storage medium of claim 10, wherein displaying the image information includes retrieving a preference associated with the image information.

12. The computer-readable storage medium of claim 3, further comprising:
retrieving the image information from the first database;
retrieving the non-image data from the second database;
displaying the image information; and
displaying the non-image data.

13. The computer-readable storage medium of claim 12, further comprising receiving a request to share the image information.

14. The computer-readable storage medium of claim 5, wherein receiving selected visual data from the selected region of the visual data further comprises displaying a visual indicator showing a boundary of the selected visual data from the selected region of the visual data.

15. The computer-readable storage medium of claim 3, wherein the non-image information includes a universal resource locator of the visual data.

16. A computer-readable storage medium having embodied thereon a program, the program being executable by a computer to perform a method for capturing and sending data, the method comprising:
receiving a send request from a computing device, the computing device having a display;
identifying a capture region within a data source, the data source being displayed on the display of the computing device;
indicating the capture region on the display;
receiving visual data based on the capture region;
receiving data associated with a recipient address;
sending a link to the recipient address, the link associated with the data source; and
sending the received visual data to the recipient address.

17. The computer-readable storage medium of claim 16, further comprising:
providing a set of categories to the computing device for selection; and
receiving a selection of a category from the computing device; and
storing image information and non-image data of the received visual data in association with the selected category.

18. The computer-readable storage medium of claim 16, wherein sending a link to the recipient address further comprises:
generating a message, the message including the link to the data source; and
sending the message.

19. The computer-readable storage medium of claim 16, wherein sending the received visual data to the recipient address further comprises:
generating a message, the message including the received visual data; and
sending the message upon generating the message.

20. A computer-readable storage medium having embodied thereon a program, the program being executable by a computer to perform a method for saving a region of a data source displayed on a display of a computing device by a browser, the method comprising:
receiving a request to save a region of the data source;
suppressing activity of the browser on the computing device;
receiving a definition of a region of the data source;
providing one or more boundaries of the defined region for display;
initiating an extraction of image data from the defined region;
initiating an extraction of non-image data from the defined region;
providing a set of categories;
receiving a selection of a category from the set of categories;
generating an item of content based on the extracted image data and the extracted non-image data; and
releasing the suppression of browser activity.

21. A method for saving visual data, the visual data that was captured from a data source, the method comprising:
receiving the visual data via a network from a computing device coupled to the network, the visual data including image data and non-image data; and
generating an item of content based on the selected visual data from the data source for storage in a database coupled to the network.

22. The method of claim 21, wherein generating the item of content comprises:
providing an organizational overlay to the computing device, the organizational overlay including a set of categories; and
receiving a selection of a category from the set of categories.

23. The method of claim 22, further comprising:
providing a category for display on the display of the computing device;
receiving a request for a style of arrangement in a category from the computing device, the category including an image associated with the image data of one or more items of content; and
providing the one or more items of content for display on the display of the computing device based on the requested style of arrangement.

24. The method of claim 21, further comprising sending an alert via the network upon generating the item of content.

25. The method of claim 21, wherein the computing device includes a mobile device.

26. The method of claim 21, further comprising:
providing an image for display on the display of the computing device, the image associated with the image data of the visual data;
receiving a user input to modify the image from the computing device; and
modifying the image in accordance with the user input.

27. The method of claim 21, further comprising:
providing an image for display on the display of the computing device, the image associated with the image data of the visual data;
receiving a user input to duplicate the item of content; and
storing the duplicated item of content.

28. The method of claim 27, wherein storing the duplicated item of content further comprises:
providing to the computing device a set of categories;
receiving from the computing device a selection from the set of categories; and
associating the item of content with the selected category.

29. A method for sharing visual data that was captured from a data source, the method comprising:
receiving visual data from a computing device coupled to the network, the computing device having a display;
generating an item of content based on the visual data received from the computing device;
receiving data associated with a recipient address from a second user input to the computing device;
sending a link to the recipient address via one or more web servers coupled to the network, the link associated with the data source; and
sending the generated item of content to the recipient address via the one or more web servers.

30. A method for saving image data and non-image data that was captured from a data source, the data source displayed on a display of a computing device by a browser, the method comprising:
receiving image data and non-image data from the data source via a network, the computing device coupled to the network;
providing a set of categories to the computing device, the set of categories received from a server coupled to the network;
receiving a selection of a category from the computing device, the selection selected from the set of categories-provided by the server; and
generating an item of content based on the image data and non-image data from the data source for storage in a database coupled to the network.
